(19) United States
(12) Patent Application Publication
(10) Pub. No.: US 2018/0141203 A1
(43) Pub. Date: May 24, 2018

(54) WORKBENCH SUPPORT SYSTEM AND A WORKBENCH ASSEMBLY ASSOCIATED THEREWITH

(71) Applicant: KETER PLASTIC LTD., Herzelyia (IL)

(72) Inventor: Yaron BRUNNER, Kibbutz Gvat (IL)

(73) Assignee: KETER PLASTIC LTD., Herzelyia (IL)

(21) Appl. No.: 15/571,673

(22) PCT Filed: May 4, 2016
(86) PCT No.: PCT/IL2016/050470

§ 371 Date: Nov. 3, 2017

Related U.S. Application Data
(60) Provisional application No. 62/156,544, filed on May 4, 2015.

(51) Int. Cl. B25H 1/04; B25H 1/16

(52) U.S. Cl. CPC B25H 1/04; B25H 1/16

(57) ABSTRACT

Provided is a workbench support systems configured with and least one utility portion and deployable between an operative position and a collapsed position, also referred to as a stowed position. Further provided are workbench assemblies including the workbench support systems and a utility member configured for articulation to the support system in an operative position and further configured to be stowed within the support system when in the collapsed position. In accordance with an example, the thickness of the assembly in the stowed position does not exceed the thickness of the workbench support system when folded.

### TECHNOLOGICAL FIELD

The present disclosure is directed to a workbench support system and more particularly it is concerned with a knockdown type or foldable workbench deployable between an operative position and a folded/stowed position.

### Background Art

References considered to be relevant as background to the presently disclosed subject matter are listed below:

US20020105129

EP2140985

Acknowledgement of the above references herein is not to be inferred as meaning that these are in any way relevant to the patentability of the presently disclosed subject matter.

### Background

Various types of workbenches and workbench assemblies are known in the art. One example disclosed in US2002105129A is directed to a workpiece support assembly which includes an elongated workpiece support structure and a pair of support members pivotally connected to one another towards upper ends thereof. The support members are pivotally movable between an open position and a folded position. The workpiece support structure has a workpiece support surface constructed and arranged to support a portion of a workpiece. The workpiece support assembly further includes a tabletop assembly. The tabletop assembly is movable into a deployed position in which the tabletop is disposed substantially horizontally in overlying relation to the workpiece support structure, with the pair of support members in their open operative position. The deployed tabletop presents an upper tabletop surface to support a workpiece. The tabletop assembly is movable, with the pair of support members in their open operative position, into a storage position which exposes the elongated workpiece support surface.

Another example disclosed in EP2140985 is directed to a workbench with a collapsible frame and a plurality of top members. The collapsible frame can include a first set of legs and a second set of legs that can be coupled to one of the top members. The frame and top members can be positioned and supported by the first and second sets of legs to form a pair of free standing structures that can be employed as work benches and/or saw horses.

### GENERAL DESCRIPTION

The present disclosed subject matter is directed to workbench support systems, the workbench support systems being configured with and least one utility portion and deployable between an operative position and a collapsed position, also referred to as a stowed position. In some aspects, the disclosed subject matter further refers to workbench assemblies comprising the workbench support systems and a utility member configured for articulation to the support system in an operative position and further configured to be stowed within the support system when in the collapsed position. In accordance with an example, the thickness of the assembly in the stowed position does not exceed the thickness of the workbench support system when folded.

In accordance with one aspect there is disclosed a workbench support system provided with a utility portion, the system comprising a first set of support legs and a second set of support legs, the first set of support legs and the second set of support legs being interconnected by at least one link member the link member comprising at least two connecting bars pivotable one with respect to the other such that one free end of each of the at least two connecting bars is pivotably connected at one end of the support legs while the other free end of the connecting bars is slidingly displacable over the other end of the opposite set of support legs, wherein in a first fully deployed position the at least one link member is in a fully deployed configuration connectably spacing apart the first set of support legs and the second set of support legs and extending in diagonal therebetween and in the collapsed position the link members being dispose substantially parallel to the first set of support legs and the second set of support legs. In accordance with an example of this aspect, in the collapsed position the link members are fully received and stowed within the set of support legs. In accordance with one example, each of the first set of support legs and the second set of support legs are connected by at least one support bar extending between each two respective legs of the first set of support legs and the second set of support legs.

In accordance with another aspect there is disclosed a workbench support system comprising a first set of support legs and a second set of support legs, wherein each of the first set and the second set of the support legs has a lower end and an upper end, wherein at least the upper end and/or the lower end comprises a vertically slidable portion, the first set of support legs and the second set of support legs being interconnected by at least one link member the link member comprising two connecting bars pivotable one with respect to the other such that one end of each of the connecting bars is pivotably connected at an upper end of the support legs while the other end of the connecting bars is pivotally connected over the lower end of the opposite set of support legs, wherein in a first fully deployed position the at least one link member is in a fully deployed configuration connectably spacing apart the first set of support legs and the second set of support legs and extending in diagonal therebetween and in the collapsed position the link members being dispose substantially parallel to the first set of support legs and the second set of support legs, wherein in the collapsed position the connecting bars slidingly displace the vertically slidable portions. In accordance with an example of this aspect, in the collapsed position the link members extend at the outer side of adjacent set of support legs.

In accordance with another aspect there is disclosed a workbench support system provided with a utility portion and manipulable between at least a first, fully expanded position and a second, fully collapsed position, the workbench support system comprising a first set of support legs and a second set of support legs, the first set of support legs and the second set of support legs being interconnected by at least one link member, wherein the link member comprises two connecting bars pivotal one with respect to the other such that one free end of each of the at least two connecting bars is pivotally connected at an upper end of the support legs while the other free end of the connecting bars is pivotally attached to a slidable sleeve disposed over the sets of the support legs at a position lower than the connecting bar thus forming a diagonal connection when in an extended position, with the two connecting bars forming an X-like link member.

Any one or more of the following features, designs and configurations, can be implemented in a system and assembly, according to the present disclosure, individually or in various combinations thereof:
further comprising a at least one utility portion, provided at the top edges of the support bars configured for supporting a utility member.
wherein a bottom part of the support system frames is provided with retractable and adjustable leg supports.
wherein the workbench support system comprises a first set of two substantially parallel disposed support legs and a second set of two support legs, the two support legs of each set being connected at their top end and their bottom end with a connecting support bar together constituting a substantially rectangular support frames.
wherein the support members are configured to receive therein a utility member when the system is in the collapsed configuration.
wherein the sliding displacement is facilitated by a rail system provided at an inner face of each of the support legs and a storage rail configured to snuggly receive therein the connecting bar associated with the opposite set of legs.
wherein the workbench support system is further provided with a locking mechanisms locking the utility member to the frame
wherein the locking mechanism is an integral part of the system or the utility member or as an add-on mechanism.
wherein system is further provided with a carrying handle.
wherein workbench is configured with one or more organizers detachably attachable thereto.
wherein the support frames are disposed in parallel in the operative configuration or are angled one with respect to the other.
wherein the thickness of the assembly comprising the utility member and the support system in the stowed position does not exceed the thickness of the workbench support system when folded.
wherein the workbench support system and or the utility member are plastic.
wherein at least part of the workbench support system is plastic.

The terms upper and lower as used herein are relative terms and should not be construed as restricting unless otherwise indicated. Thus, by using the term upper reference is made to a portion extending towards the top of the referenced element while the term lower, is used as a relative term and can refer to any position spaced from the upper end.

The term utility portion as used herein in the specification and claims defines any sort of arrangement configured for supporting a workspace, utility member and the like. For example, a utility portion can be a flat surface (e.g. for supporting a board of material) or a notch configured for supporting an elongate workpiece (being for example a V-notch, a right-angled notch, a semicircular notch and the like).

The term utility member as used herein in the specification and claims defines any sort of arrangement configured for supporting a workpiece or a worktool and supportable over the utility portion. For example, a utility member can be a unitary flat surface (e.g. a board, workbench tabletop) with or without workpiece/worktool supporting arrangement such as rails, slots, notches, openings, hooks etc.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a perspective side view of the workbench support system (a) in accordance with an example of the disclosed subject matter and a separate utility member seen in a perspective side view (b) and a perspective bottom view (c);

FIG. 1B illustrates a workbench assembly in accordance with an example of the disclosed subject matter;

FIG. 1C and FIG. 1D illustrate side perspective views of the workbench support system of FIG. 1A in a fully folded position;

FIG. 1E to FIG. 1G illustrate the workbench support system of FIG. 1C with various types of utility members stowed therewithin in accordance with an example of the disclosed subject matter;

FIG. 1H is another perspective side view of the workbench support system of FIG. 1A in accordance with an example of the disclosed subject matter;

FIG. 1I is an enlarged view of section C in FIG. 1H while FIG. 1J illustrates the opposite side of the workbench support system in an enlarged view (marked B in FIG. 1J);

FIG. 2A illustrates a workbench assembly supporting two workpieces therein in accordance with an example of the disclosed subject matter;

FIG. 2B illustrates a workbench assembly supporting a mitre saw thereon in accordance with an example of the disclosed subject matter;

FIG. 2C illustrates an extended workbench configured from two workbench assemblies supporting an add on unit with a mitre saw thereon in accordance with an example of the disclosed subject matter;

FIGS. 2D and 2E illustrate a workbench assembly provided with extension members (best seen in FIG. 2D) for supporting a wooden plate table top thereon (FIG. 2E) in accordance with an example of the disclosed subject matter;

FIG. 3A is a perspective side view of the workbench support system (a) in accordance with an example of the disclosed subject matter and a separate utility member seen in a perspective side view (b);

FIG. 3B illustrates in a perspective front view a workbench assembly in accordance with an example of the disclosed subject matter;

FIG. 3C illustrates the side view of the workbench assembly of FIG. 3B turned sideways by about 90 degrees;

FIG. 3D is a side view of the workbench of FIG. 3A and FIG. 3E is a front view thereof;

FIG. 4A illustrates a perspective view of the workbench support system of FIG. 3A in a fully folded position (a) with the utility member seen is a bottom perspective view (b);

FIG. 4B illustrates the folded workbench support system of FIG. 4A from in a side view;

FIG. 5 is a front view of the workbench support system of FIGS. 4A and 4B fitted with the utility member seen in FIG. 3A (b);

FIG. 6A to FIG. 6C illustrate the workbench support system and the assembly in various operational configurations supporting workpieces;

FIG. 7A to FIG. 7D illustrate a workbench support system in accordance with another example of the disclosed subject matter, the workbench having extendable support legs (FIG. 7C showing the extended position);

FIG. 8A and FIG. 8B illustrate the front and side views of the workbench support system of FIG. 7A in a folded configuration; and

FIG. 9A to FIG. 9D illustrate the workbench support system of FIG. 7A in various operational configurations supporting workpieces and worktools.

### DETAILED DESCRIPTION OF EMBODIMENTS

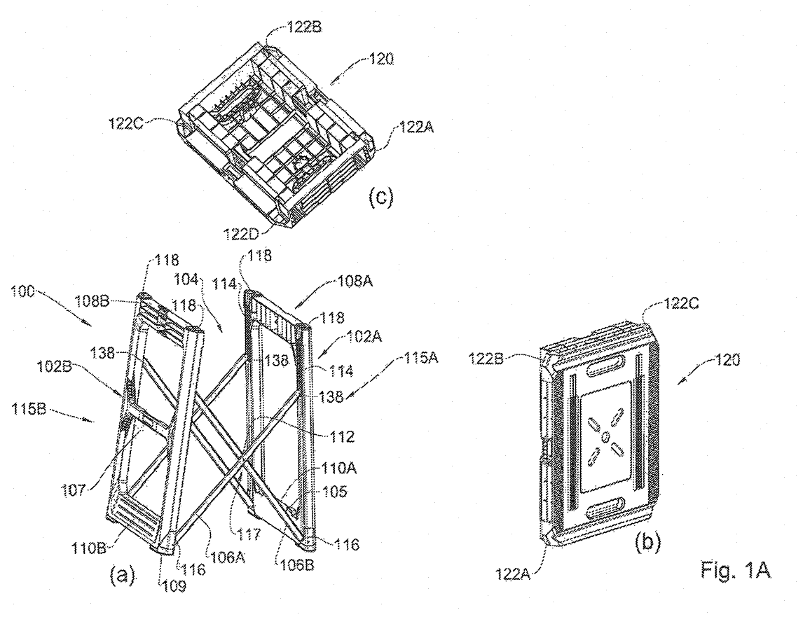

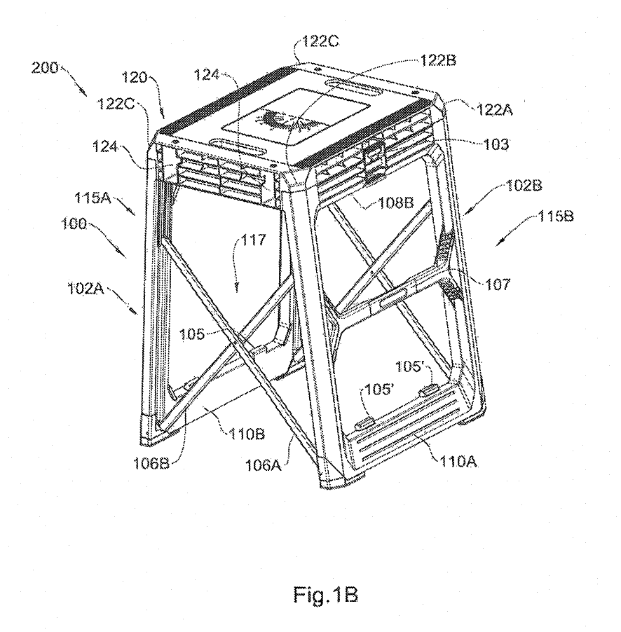

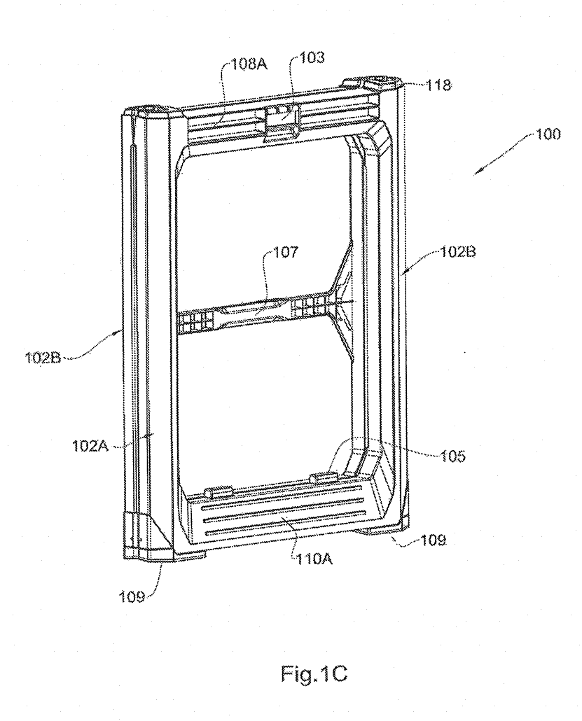

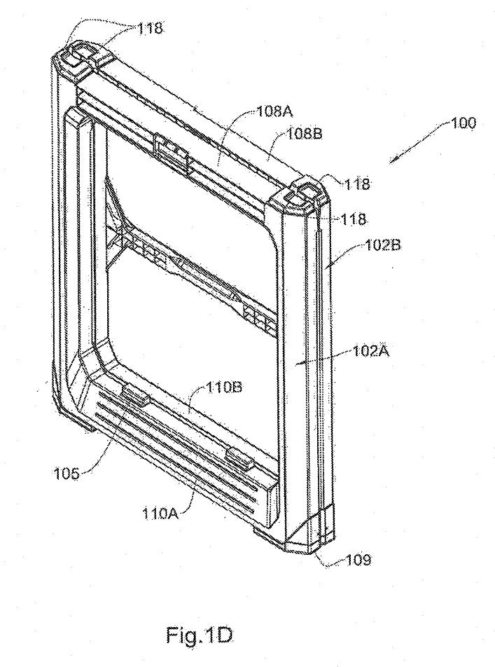

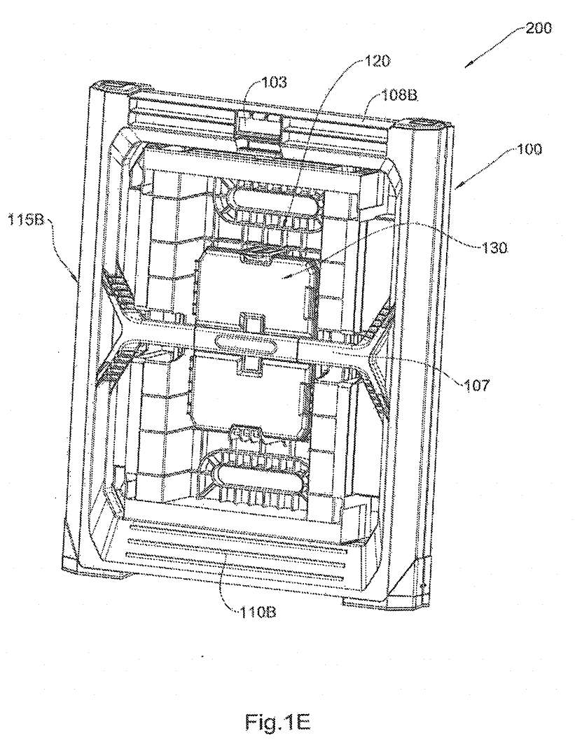

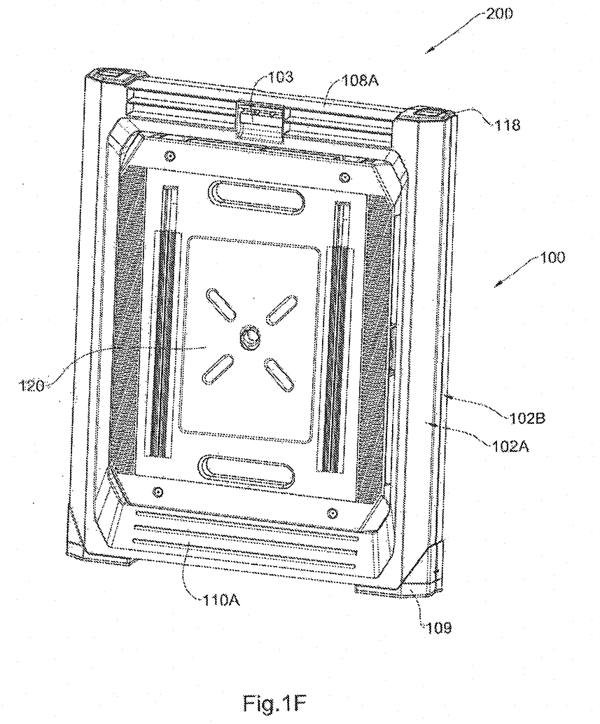

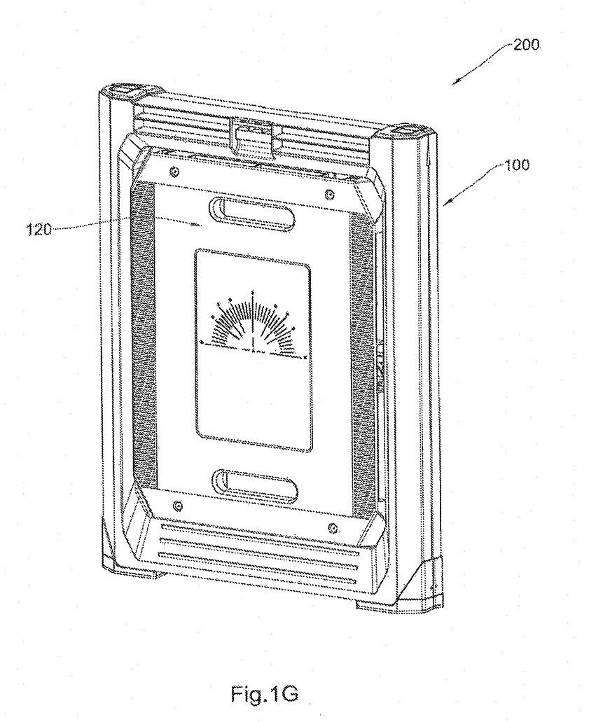

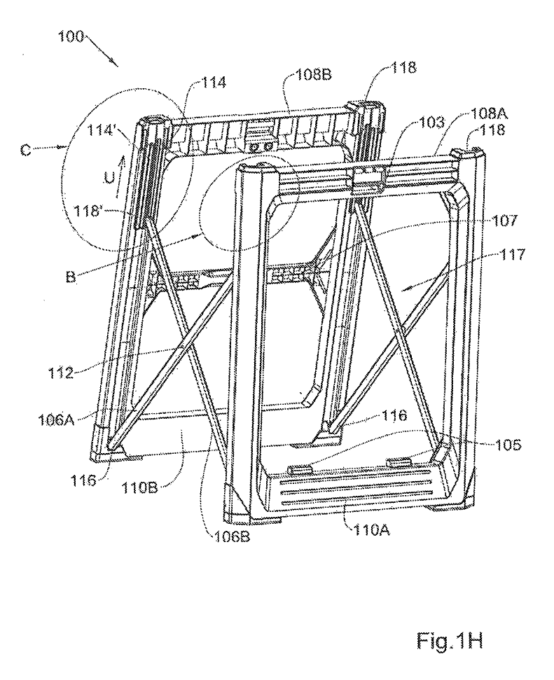

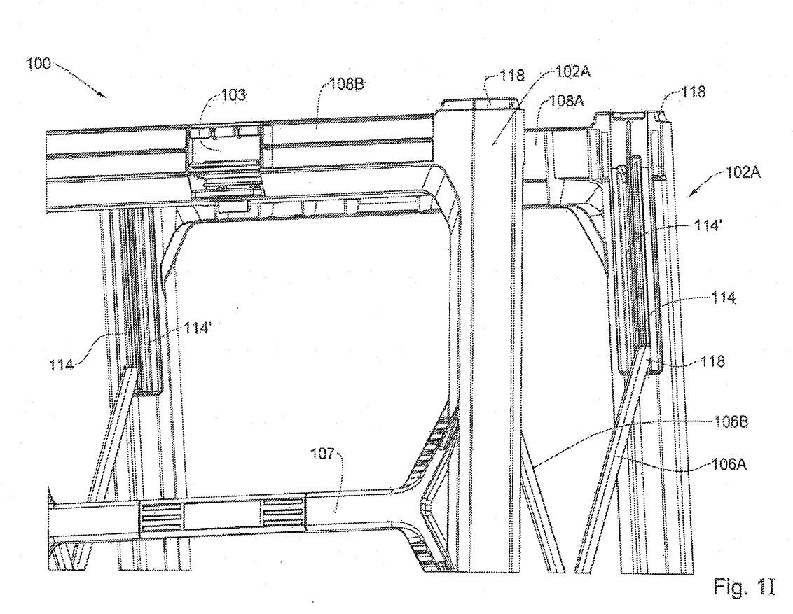

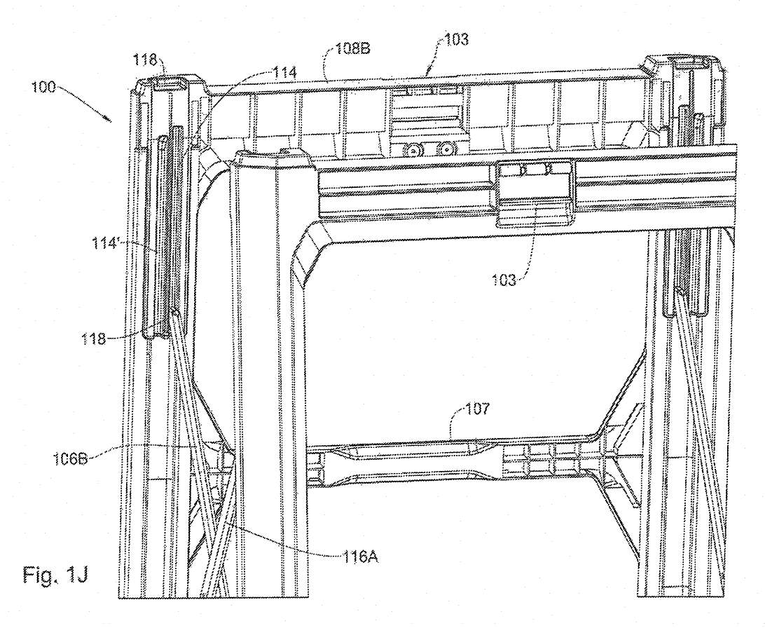

Attention is directed to FIGS. 1A, 1C, 1D, 1H to 1J illustrating a workbench support systems in accordance with an example of the disclosed subject matter and generally designated 100. The workbench support systems 100 is configured with at least one utility portion 118 (as will be discussed) and deployable between an operative position seen e.g. in FIGS. 1A and 1H and a collapsed position seen e.g. in FIGS. 1C and 1D. This collapsed position will be interchangeably referred to as a stowed position. As will be discussed herein, in accordance with some examples, the disclosed subject matter further refers to workbench assemblies comprising any one of the workbench support systems of the present subject matter and a utility member generally designated 120 (seen in e.g. FIG. 1A) configured for articulation to the support system 100 in an operative position (as seen e.g. in FIG. 1B) and further configured to be stowed within the support system 100 when in the collapsed position (as seen e.g. in FIGS. 1E-1G). In accordance with an example and as illustrated in FIGS. 1E-1G the thickness of the assembly 200 in the stowed position does not exceed the thickness of the workbench support system 100 when collapsed. In accordance with another example, the workbench support assembly can be configured to receive the utility member between the frames 115 such that larger utility members can be used. In accordance with another example, the workbench support system can be stowed within a respective cavity formed at the bottom surface of the utility member (not shown).

The workbench support system 100 comprises a first set of two substantially parallel disposed support legs 102A and a second set of two support legs 102B. The two support legs of each set 102A and 102B are connected at their top end with a connecting support bar 108A and 108B respectively and at their bottom end with a support bar 110A and 110B, respectively, together constituting a substantially rectangular frames 115A and 115B, respectively. The first set of support legs 102A and the second set of support legs 102B are interconnected by a link member 117 disposed at each side of the support system. The link member 117 comprising at least two connecting bars 106A and 106B pivotable one with respect to the other at a pivot point 112 such that one free end 116 of each of the at least two connecting bars is pivotably connected at a lower end of the support legs 102A and 102B while the other free end 138 of the connecting bars 106A and 106B is slidingly displacable over the upper end of the opposite set of support legs 102B and 102A. In accordance with the example of FIG. 1A, the sliding displacement is facilitated by a rail system 114 provided at an inner face of each of the support legs. Adjacent the displacement rail there is further provided a storage rail 114′ (best seen in FIGS. 1I and 1J) configured to snuggly receive therein the connecting bar associated with the opposite set of legs (as will be discussed hereinafter). In a first fully deployed position seen e.g. in FIGS. 1A and 1H the link members 117 are in a fully deployed configuration connectably spacing apart the first set of support legs 102A and the second set of support legs 102B with the connecting bars 106A and 160B extending in diagonal therebetween and in the collapsed position the link members 117 being disposed substantially in parallel to the first set of support legs 102A and the second set of support legs 102B.

As mentioned above, the inner face of each of the support legs is provided with a rail system 114. This rail system 114 allows the end 138 of each of the connecting bars 106a and 106B to slide therewithin thereby adjusting the distance between the two sets of support legs 102A and 102B. Thus when folding the support system from the position seen in FIG. 1A to the position illustrated e.g. in FIG. 1D, the free ends 138 of the connecting bars 106A and 106B on each side of the system 100 slide in the direction indicated by arrow U in FIG. 1H. The pivot 112 along with the pivot points at the ends 116 of the connecting bars in association with the set of support legs translate the position of the connecting bars from diagonal to vertical configuration, bringing together the two frames 115A and 115B such that the inner faces of the frames are substantially flush with each other and the opposite support legs abutting each other. To allow this tight configuration, there is provide a storage rail 114′ adjacent each rail 114 so as to stow the connecting bar connected at an opposite end to the respective rail 114 (best seen in FIGS. 1I and 1J).

The work bench support system is further provided with at least one utility portion designated 118 in FIGS. 1A to 1J. This utility portion is in the form of outwardly protruding support members provided at the top edges of the support bars 108A and 108B. These support members 118 are configured for supporting a workbench surface, a workspace and the like. Although in this example the utility portion is in the form of a flat protruding member it will be appreciated that other types of supports are envisioned such as a notch configured for supporting an elongate workpiece (being for example a V-notch, a right-angled notch, a semicircular notch and the like some of which will be discussed with respect to further examples of the present disclosed subject matter).

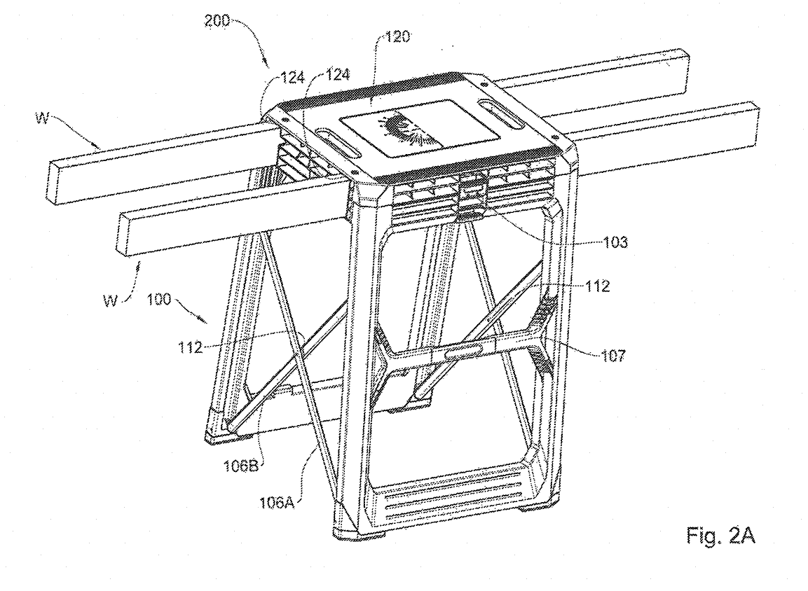

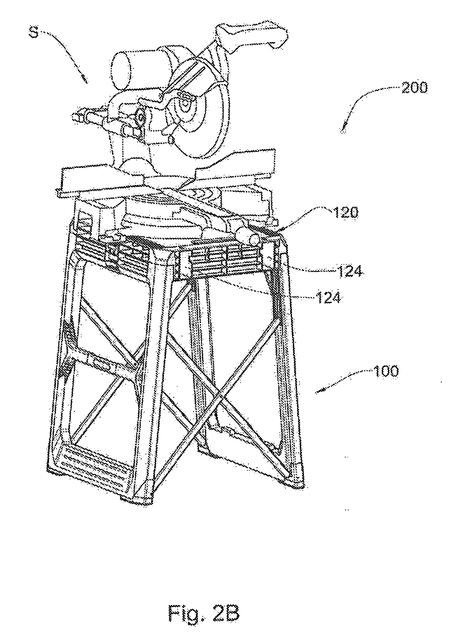

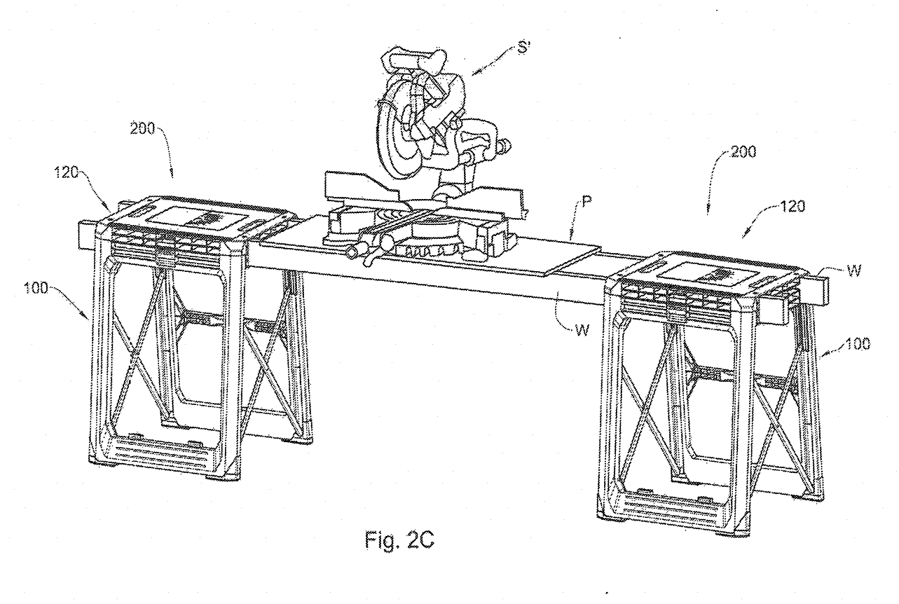

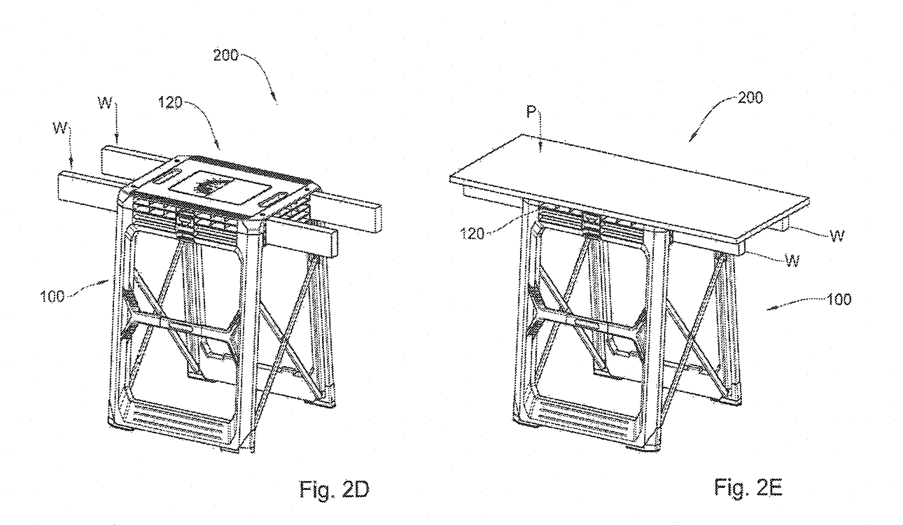

The present disclosed subject matter is further directed to a utility member generally designated 120 which constitutes a workbench surface for holding tools and refers to any sort of arrangement configured for supporting a workpiece or a worktool and supportable over the utility portion (e.g. FIG. 2A, 2B, 2E). For example, a utility member can be a unitary flat surface (e.g. a board, workbench tabletop) with or without workpiece/worktool supporting arrangement such as rails, slots, notches, openings, hooks etc. various examples of the utility member are illustrated in FIGS. 1A, 1E, 1F, 1G, 2F to 2E etc. Alternatively the utility member can be configured with modular work utilities, either fixed or replaceable. For example, such work utilities can comprise T-slots (FIGS. 1A and 1F), router plates, router fences, measurement indicia, coupling ports, etc. The utility member 120 is articulated to the workbench support system over the utility portion thereof via respective nooks 122A to 122D (seen in FIG. 1A(c)), adapted to snuggly receive the support members 118. It will be appreciated that other types of articulations are possible including providing the utility member with an anti skid surface or suction cups etc to rest of the edge of the support bar 108. In accordance with an example illustrated e.g. in FIG. 1B, the workbench support system is further provided with a latch 103 configured to lock over the utility member securing it in place as seen in FIG. 1B in the locked position and FIG. 1I in the resting, unlocked position. This latch is optional and other means if any of locking mechanisms are envisioned, including locks, hooks etc.

When the workbench support system is in a collapsed position (e.g. as seen in FIGS. 1E to 1G), the utility member is configured in its dimensions to be received within the space formed by frames constituted by the support bars 108A and 108B, 110A and 110B and the two sets of the support legs. To avoid unintentional displacement of the utility member, the frame is provided with a locking mechanism for locking the utility member thereto, in the illustrated example this is achieved by the locking teeth 105 which are snapped into respective openings provided on the edges of the utility member, in this case constituted by the openings formed by the strength enhancing ribs at the side walls of the utility member 120. While in the examples of FIGS. 1a and 1H, one side of the support bars 110A is provided with the teeth 105, as seen in FIG. 1B, both support bars can be configured with the respective teeth 105 and 105′ such that when the utility member is locked thereover, it snuggly locks over both support frames 110A and 110B. It will be appreciated that other locking mechanisms can be provided either as integral part of the system or the utility member or as an add-on mechanism. As seen best in FIGS. 1E to 1G, in the stowed configuration the assembly is compactly folded and can be easily stored and transported.

The assembly can be provided with a carrying handle for example, e.g. element 107 provided on one of the frame 115B and extending between the two support legs thereof. It will be appreciated that other configurations are envisioned, e.g. a handle provided at the sides of the support frame, a retractable handle and the like. The workbench assembly 200 seen in FIG. 1E for example is configured with one or more organizers 130 (e.g. screw organizers) detachably attachable thereto. According to this particular example an organizer is detachably attachable at a bottom face of the utility member 120. The organizer can be configured for sealing attachment to the utility member.

The utility member can be configured with receptacles/compartments/trays configured at the top face thereof (not shown). Optionally such compartments can be drawer-like receptacles configured at side walls of the utility member. According to another example an as seen in FIG. 1B, the utility member is provided with two horizontally extending channels 122 (i.e. extending substantially perpendicular to the support legs) configured to receive therethrough a workpiece W, as shown in FIG. 2A. the channels can have any desired geometrical shape and dimensions to allow passing through of the respective workpiece. As seen in FIGS. 2C to 2E, this allows not only support for the workpiece W, in this example a dimensional lumber (2×4), but also modularity of the assembly which can be used as seen in FIG. 2C with another assembly 200, or a sawhorse etc. to provide for a larger workspace for carrying larger machine tools such as the saw seen in FIG. 2C.

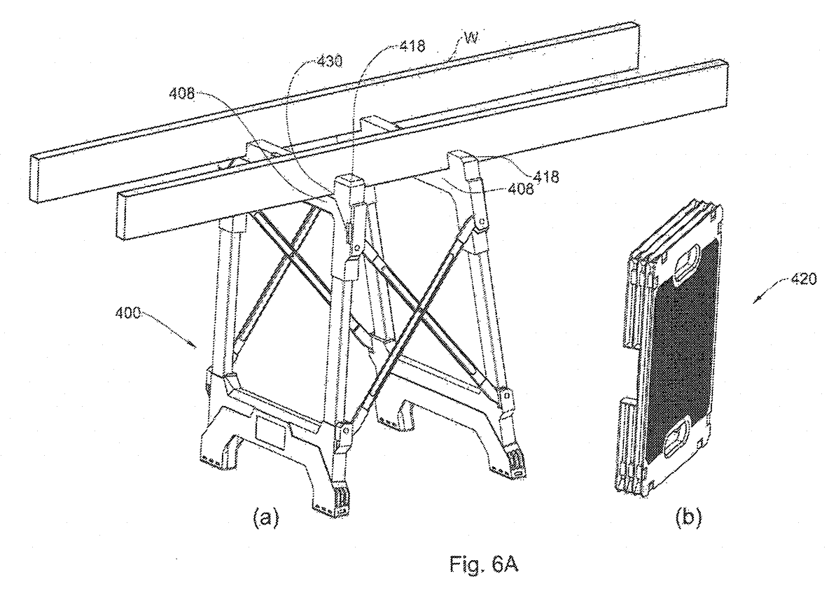

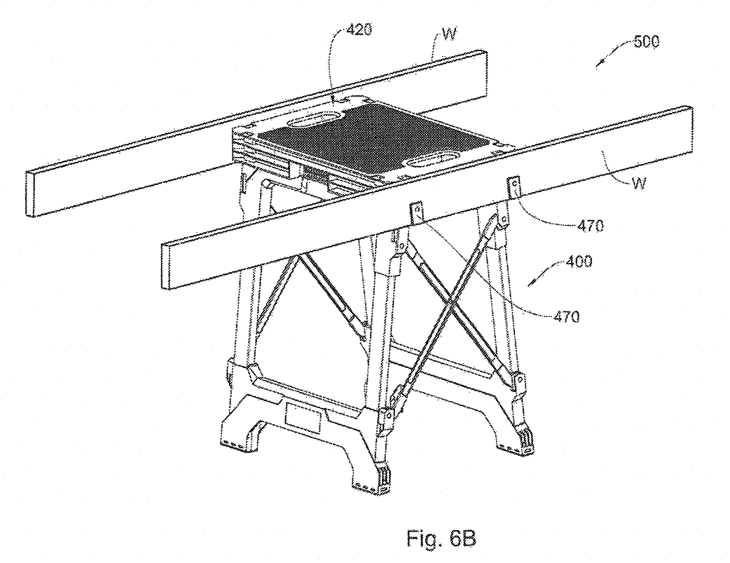

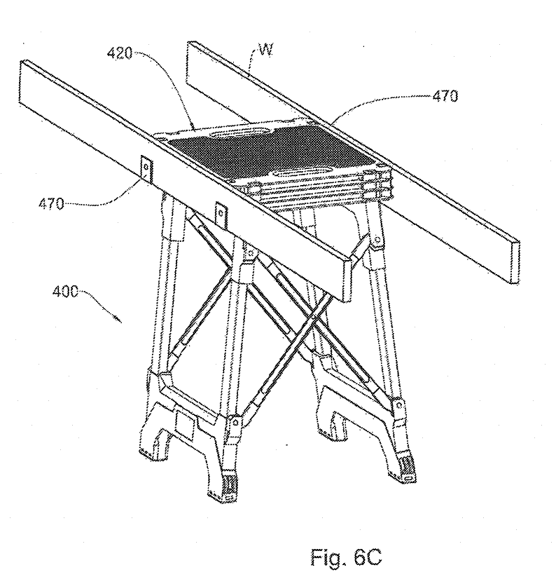

The utility member 120 (as well as 420 described with reference to assembly 500) can be configured for detachably attaching thereto utility hooks e.g. as seen in FIGS. 6B and 6C with reference to workbench assembly 500. Such utility hooks can be used for example for mounting thereon various equipment/gear and for supporting beams which can facilitate for setting up an extended work surface, a scaffold, etc. The utility hooks can be configured for supporting rectangle cross-sectioned beams (e.g. 2×4 dimensional lumber).

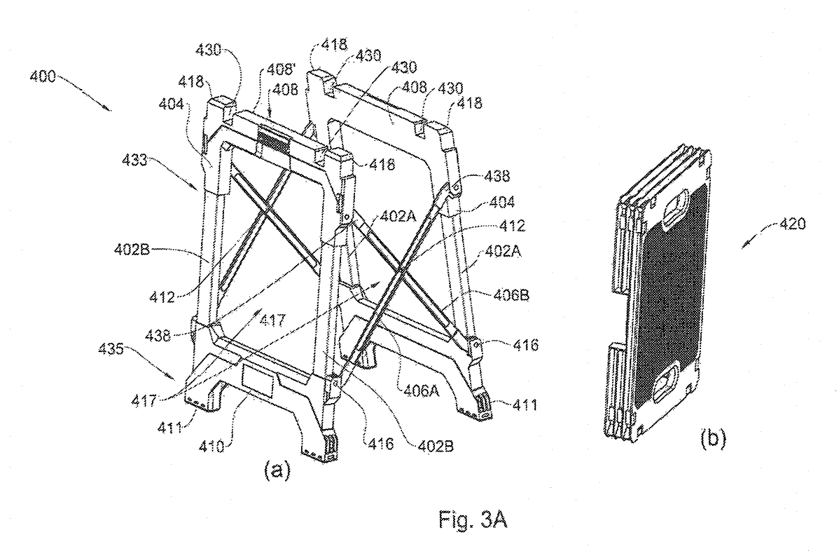

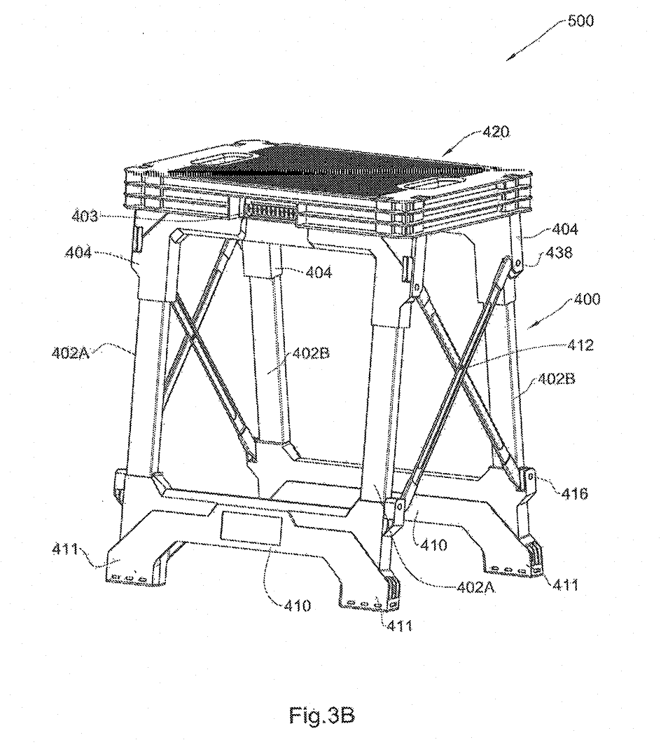

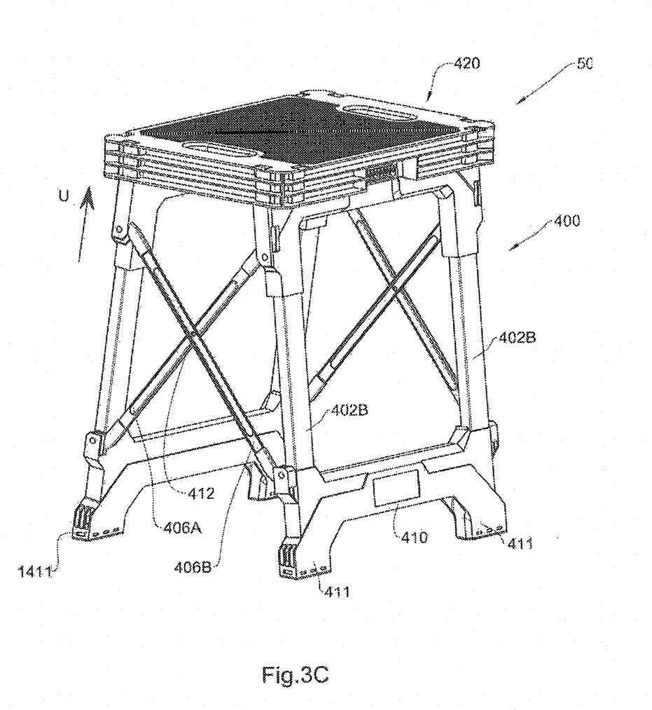

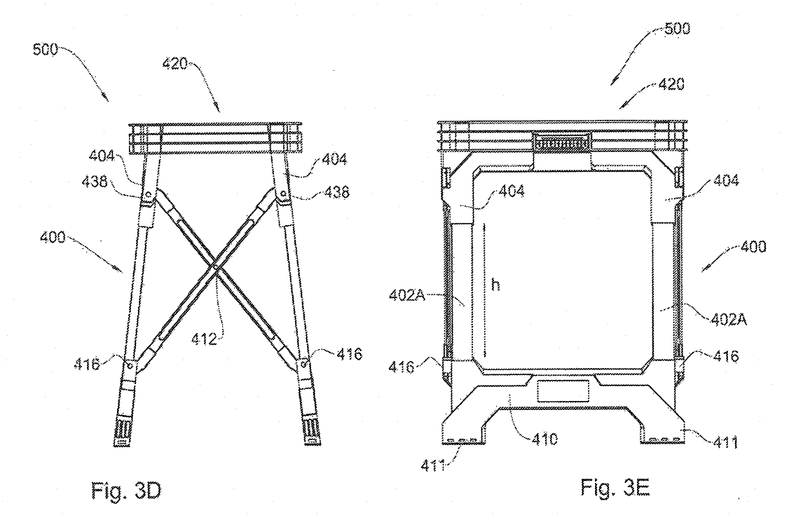

Turning to the examples illustrated in FIGS. 3A to 6C and FIGS. 7A to 9D wherein like reference numerals upped by 300 and 500, respectively, refer to like parts as in the previous example, reference numeral 400 and 600 generally designate the workbench support assembly in accordance with another example of the disclosed subject matter.

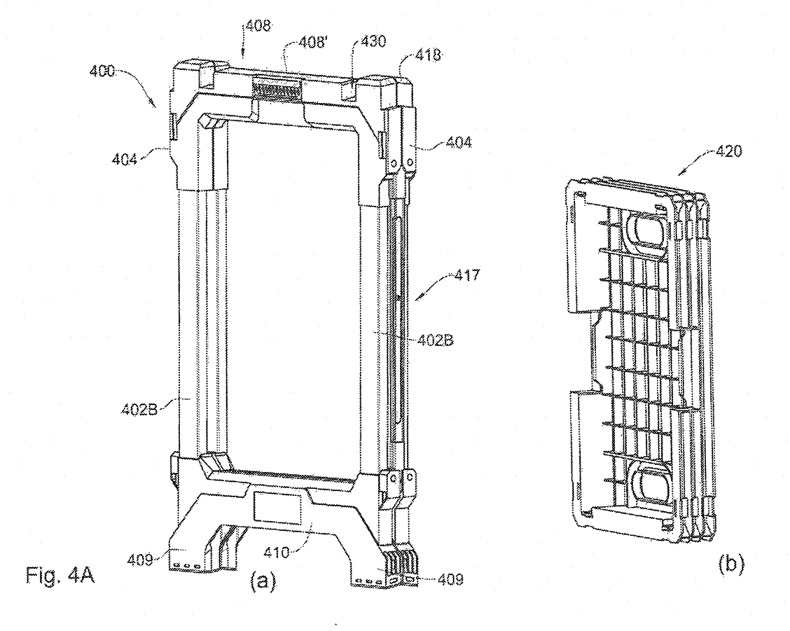

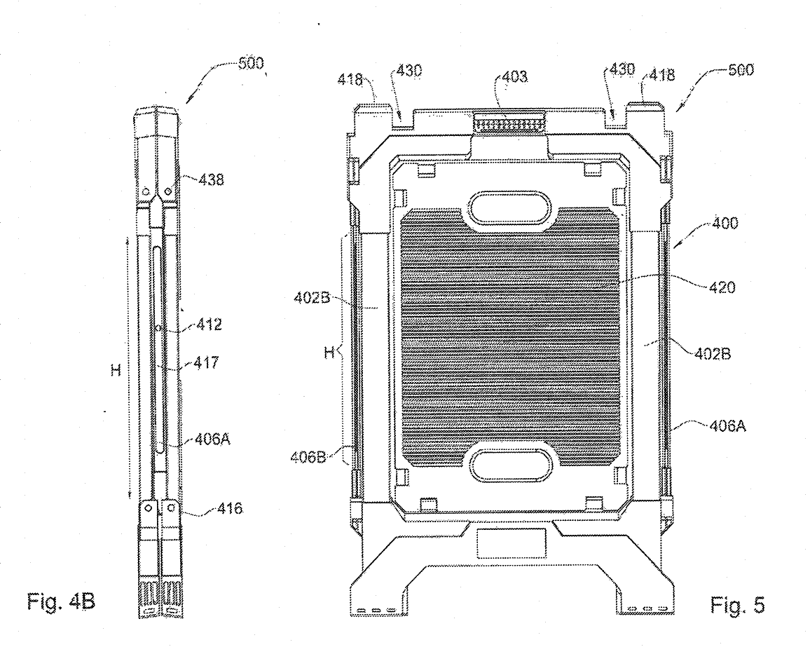

As seen in FIG. 3A, there is provided a workbench support system 400 which as in the previous example is configured with a utility portion 418, 430 (as will be discussed) and deployable between an operative position seen e.g. in FIGS. 3A and 3B and a collapsed position seen e.g. in FIGS. 4A and 5. As discussed above, in accordance with some examples, the disclosed subject matter further refers to workbench assemblies 500 comprising the workbench support system 400 and a utility member generally designated 420 (seen in e.g. FIG. 3A) configured for articulation to the support system 400 in an operable position (as seen e.g. in FIG. 3B) and further configured to be stowed within the support system 400 when in the collapsed position (as seen e.g. in FIG. 4B and FIG. 5).

The workbench support system 400 comprises a first set of two substantially parallel disposed support legs 402A and a second set of two support legs 402B. The two support legs of each set 402A and 402B are connected at their top end with a connecting support bar 408 and at their bottom end with a support bar 410, together constituting substantially rectangular side frames 415. The connecting bar 408 in this example is a sliding member, comprising two downwardly extending substantially vertical sleeve like cavities 404 connected by a horizontal bar 408′, each cavity configured to be slidingly mounted on the respective support leg 102. The bottom bar 410 is fixedly attached to the opposite side of the support legs. As in the previous example the two frames 415 are interconnected by a link member 417 at each side. The link member 417 in the present example comprises two connecting bars 406A and 406B pivotable one with respect to the other at a pivot point 412 such that one free end 416 of each of the at least two connecting bars is pivotally connected at a lower end of the support legs 402A and 402B while the other free end 438 of the connecting bars 406A and 406B is pivotally attached to the sleeve 404 at the upper end of the opposite set of support legs 402B. In accordance with the example of FIG. 3A, the sliding displacement of the link member is facilitated by the movement of the sleeve 404 over the respective leg support. In a first fully deployed position seen e.g. in FIG. 3A the link members 417 are in a fully deployed configuration connectably spacing apart the first set of support legs 402A and the second set of support legs 402B with the connecting bars 406A and 406B extending in diagonal therebetween connected at a pivot point 412 forming a pivotal X-like link member 417 and in the collapsed position the link members 417 being disposed substantially in parallel to the first set of support legs 402A and the second set of support legs 402B. As mentioned above, each of the support legs is provided with a sleeve like sliding member 404. This sleeve like sliding system allows the end 438 of each of the connecting bars 406a and 406B to slidingly extend form the diagonal position to a vertical position thereby adjusting the distance between the two sets of support legs 402A and 402B and consequently to bring together the two opposite frames 415. Thus when folding the support system from the position seen in FIG. 3A to the position illustrated e.g. in FIGS. 4A and 5, the ends 438 of the connecting bars 406A and 406B articulated to the respective sleeves 404 on each side of the system 400 slide in the direction indicated by arrow U in FIG. 3C. The distance can be defined H-h, where h is the length of the leg between the support bars 408 and 410 when in the expanded, operational position and H being the distance while in the collapsed position. The pivot 412 along with the pivot points at the ends 416 and 438 of the connecting bars in association with the set of support legs translate the position of the connecting bars from diagonal to vertical configuration, bringing together the two frames 415 such that the inner faces of the frames are substantially flush with each other and the opposite support legs abutting each other.

In accordance with this example as best seen in FIGS. 4A and 4B, in the collapsed position the link members 417 extend at the outer side of adjacent set of support legs 402A and 402B.

As in the previous example, the workbench support system is provided with a utility portion 418 configured to secure a detachably attachable utility member (e.g. as seen in FIGS. 3A and 4A (b), although other types of utility members can be provided as disclosed with respect to any other example of the disclosed subject matter and as defined herein) thereon as illustrated in FIGS. 3B to 3E. In addition, as in the previous example, the utility member can be snuggly stowed within the space defined by the support bars and the support legs. In addition, in this example the workbench support system further comprises a utility portion 430 in the form of a right-angled notch configured for supporting an elongate workpiece (best seen in FIGS. 5 and 6A in operation supporting a workpieces w).

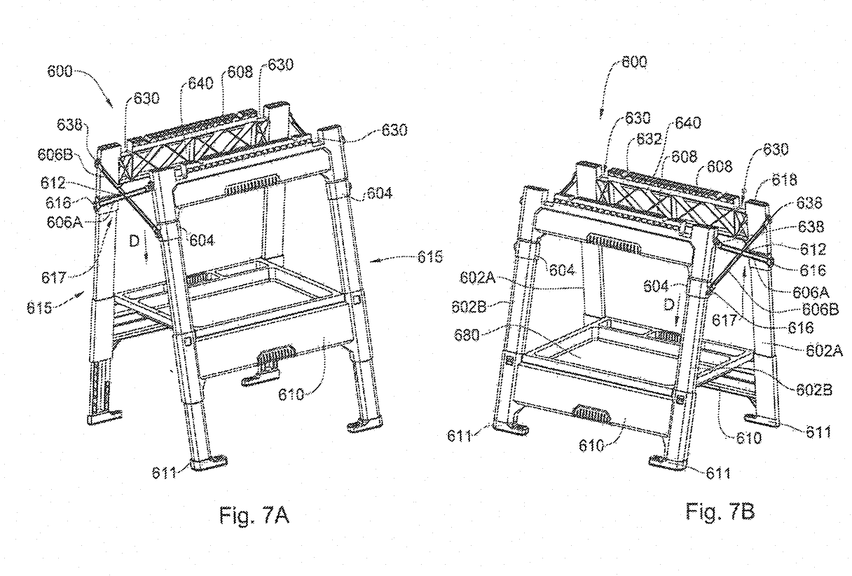

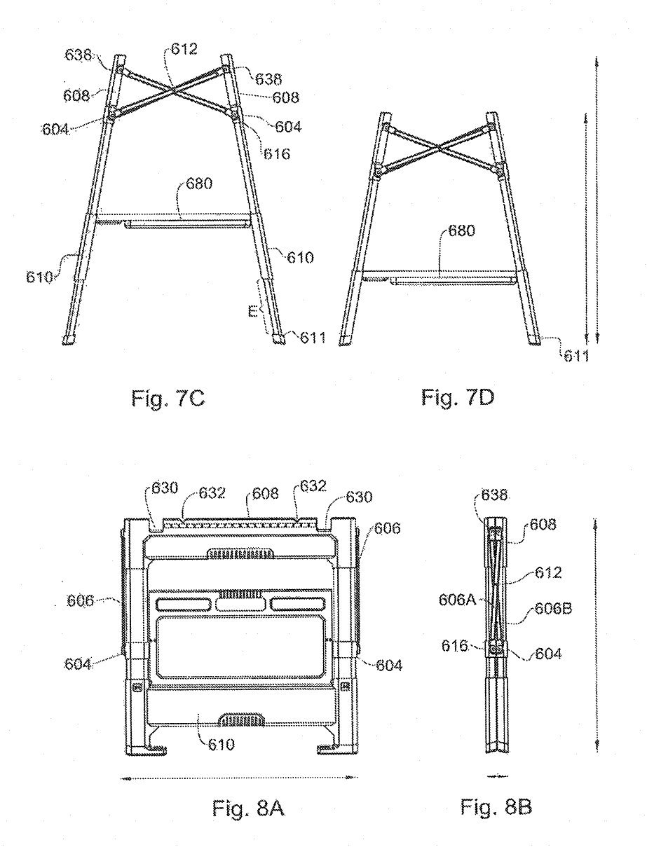

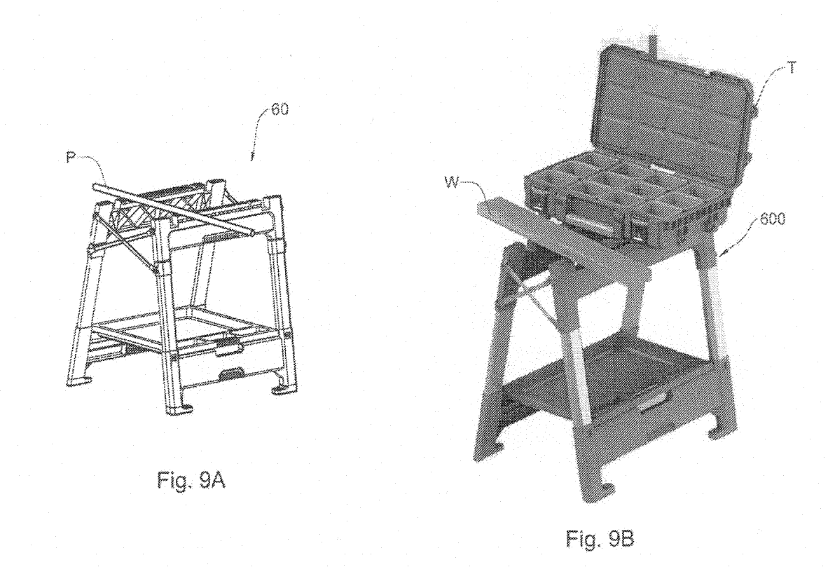

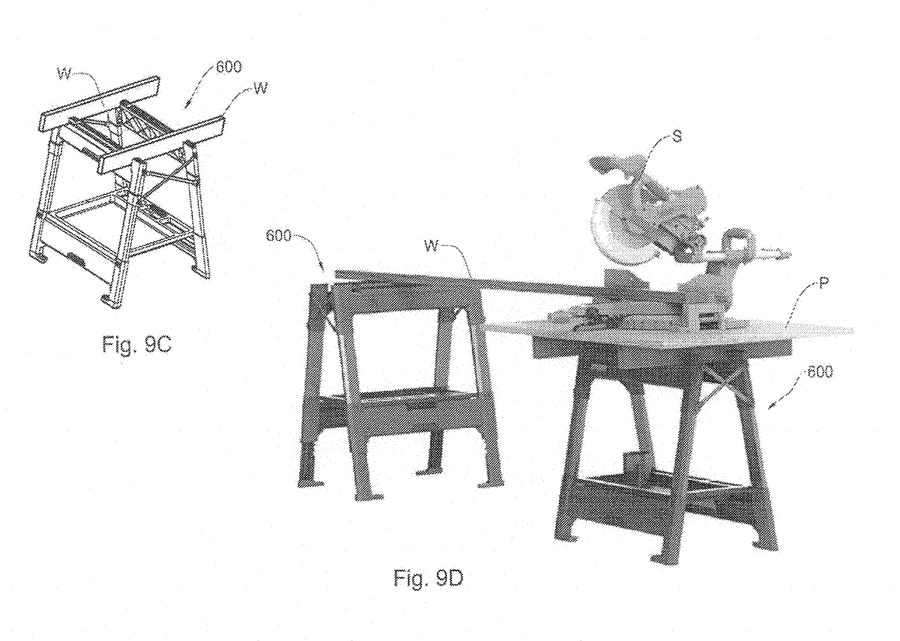

The workbench support system 600 of the disclosed subject matter illustrated in FIGS. 7A to 9D differs from the previous workbench support systems in that it is a combination of a support system and a sawhorse. The bottom part 610 of the support system frames 615 is provided with retractable and adjustable leg supports 611 and disposed between the frames there is provided a tray 680 configured for holding various articles, such as tools, screws etc. As in the previous example, the workbench support system 600 is provided with a utility portion 618 configured to secure a detachably attachable utility member (not shown). In addition, as in the previous example, the workbench support system 600 further comprises a utility portion 630 in the form of a right-angled notch configured for supporting an elongate workpiece w (best seen in FIGS. 9C and 9D in operation supporting a workpieces w). A further utility portion 432 is provide in the form of a v-like notch also configured to hold a workpiece as desired. The difference between the workbench support system 400 and the present example is in the configuration of the link member 617.

As in the previous example the two frames 615 are interconnected by link members 617 at their sides. The link members 617 in the present example comprise two connecting bars 606A and 606B pivotal one with respect to the other at a pivot point 612 such that one free end 638 of each of the at least two connecting bars is pivotally connected at an upper end of the support legs 602A and 602B in this example to the support bar 608 while the other free end 616 of the connecting bars 606A and 606B is pivotally attached to a slidable sleeve 604 disposed over the support legs 602a and 602B at a position lower than the upper connecting bar 608. The free end 616 connects to the sleeve 604 of the opposite set of support legs 602B to that of the end 638 thus forming a diagonal connection when in an extended position, with the two connecting bars 606A and 606B forming an X-like link member 617. In accordance with the example of FIG. 7A, the sliding displacement of the link member is facilitated by the movement of the sleeve 604 in the direction of arrow D over the respective leg support. In a first fully deployed position seen e.g. in FIG. 7A the link members 617 are in a fully deployed configuration connectably spacing apart the first set of support legs 602A and the second set of support legs 602B with the connecting bars 606A and 606B extending in diagonal therebetween connected at a pivot point 412 forming a pivotal X-like link member 617 and in the collapsed position the link members 617 being disposed substantially in parallel to the first set of support legs 602A and the second set of support legs 602B. As mentioned above, each of the support legs is provided with a sleeve like sliding member 604. This sleeve like sliding system allows the end 416 of each of the connecting bars 606a and 606B to slidingly extend form the diagonal position to a vertical position thereby adjusting the distance between the two sets of support legs 602A and 602B and consequently to bring together the two opposite frames 615. Thus when folding the support system from the position seen in FIG. 7A to the position illustrated e.g. in FIGS. 8A and 8B, the free ends 616 of the connecting bars 606A and 606B articulated to the respective sleeves 604 on each side of the system 600 slide in the direction indicated by arrow D in FIG. 6A. The pivot 612 along with the pivot points at the ends 616 and 638 of the connecting bars in association with the set of support legs translate the position of the connecting bars from diagonal to vertical configuration, bringing together the two frames 615 such that the inner faces of the frames are substantially flush with each other and the opposite support legs abutting each other. It will be appreciated that while in the present example the link member 617 is disposed substantially at the upper portion of the support system to enhance the structural strength of the system when in operation, it can be positioned along the frame at any desired position. As seen in this example, the frames are angled one with respect to the other, contributing to its saw horse like structure.

1.-17. (canceled)

18. A workbench support system provided with a utility portion and manipulable between at least a first, fully expanded position and a second, fully collapsed position, the workbench support system comprising a first set of support legs and a second set of support legs, the first set of support legs and the second set of support legs being interconnected by at least one link member, the link member comprising at least two connecting bars pivotable one with respect to the other such that one free end of each of the at least two connecting bars is pivotably connected at a lower end of the support legs, while the other free end of the connecting bars is slidingly displaceable over the upper end of the opposite set of support legs,
wherein in a first fully deployed position the at least one link member is in a fully deployed configuration connectably spacing apart the first set of support legs and the second set of support legs and extending in diagonal therebetween, and in the collapsed position the link members being dispose substantially parallel to the first set of support legs and the second set of support legs.

19. The workbench of claim 18, wherein in the collapsed position, the link members are fully received and stowed within the set of support legs.

20. The workbench support system of claim 18, further comprising at least one utility portion, provided at top edges of support bars configured for supporting a utility member.

21. The workbench support system of claim 18, comprising a first set of two substantially parallel disposed support legs and a second set of two support legs, the two support legs of each set being connected at their top end and their bottom end with a connecting support bar, together constituting substantially rectangular support frames, optionally wherein the support frames are disposed in parallel in the operative configuration or are angled one with respect to the other.

22. The workbench support system of claim 18, wherein sliding displacement is facilitated by a rail system provided at an inner face of each of the support legs and a storage rail configured to snuggly receive therein the connecting bar associated with the opposite set of legs.

23. The workbench support system of claim 18, further provided with at least one of (i) a locking mechanisms locking a utility member to the workbench support system, (ii) a carrying handle, or (iii) one or more organizers detachably attachable thereto.

24. The workbench support system of claim 18, being configured with and least one utility portion configured to receive a utility member and deployable between an operative position and a collapsed position, the utility member being configured for articulation to the support system in an operative position and further configured to be stowed within the support system when in the collapsed position, wherein the thickness of an assembly comprising the utility member and the support system in the stowed position does not exceed the thickness of the workbench support system when folded.

25. A workbench support system comprising a first set of support legs and a second set of support legs, wherein each of the first set and the second set of the support legs has a lower end and an upper end, wherein the upper end and/or the lower end comprises a vertically slidable portion, the first set of support legs and the second set of support legs being interconnected by at least one link member,
the link member comprising two connecting bars pivotable one with respect to the other, such that one end of each of the connecting bars is pivotably connected at a lower end of the support legs while the other end of the connecting bars is pivotally connected over the upper end of the opposite set of support legs,
wherein in a first fully deployed position the at least one link member is in a fully deployed configuration connectably spacing apart the first set of support legs and the second set of support legs and extending in diagonal therebetween, and in the collapsed position the link members being dispose substantially parallel to the first set of support legs and the second set of support legs, wherein in the collapsed position the connecting bars slidingly displace the vertically slidable portions.

26. The workbench of claim 25, wherein in the collapsed position, the link members extend at the side of adjacent set of support legs.

27. The workbench support system of claim 25, further comprising at least one utility portion, provided at top edges of support bars configured for supporting a utility member.

28. The workbench support system of claim 25, comprising a first set of two substantially parallel disposed support legs and a second set of two support legs, the two support legs of each set being connected at their top end and their bottom end with a connecting support bar, together constituting substantially rectangular support frames, optionally wherein the support frames are disposed in parallel in the operative configuration or are angled one with respect to the other.

29. The workbench support system of claim 25, wherein sliding displacement is facilitated by a rail system provided at an inner face of each of the support legs and a storage rail configured to snuggly receive therein the connecting bar associated with the opposite set of legs.

30. The workbench support system of claim 25, further provided with at least one of (i) a locking mechanisms locking a utility member to the workbench support system, (ii) a carrying handle, or (iii) one or more organizers detachably attachable thereto.

31. The workbench support system of claim 25, being configured with and least one utility portion configured to receive a utility member and deployable between an operative position and a collapsed position, the utility member being configured for articulation to the support system in an operative position and further configured to be stowed within the support system when in the collapsed position, wherein the thickness of an assembly comprising the utility member and the support system in the stowed position does not exceed the thickness of the workbench support system when folded.

32. A workbench support system provided with a utility portion and manipulable between at least a first, fully expanded position and a second, fully collapsed position, the workbench support system comprising a first set of support legs and a second set of support legs, the first set of support legs and the second set of support legs being interconnected by at least one link member, wherein the link member comprises two connecting bars pivotal one with respect to the other such that one free end of each of the at least two connecting bars is pivotally connected at an upper end of the support legs while the other free end of the connecting bars is pivotally attached to a slidable sleeve disposed over the sets of the support legs at a position lower than the connecting bar thus forming a diagonal connection when in an extended position, with the two connecting bars forming an X-like link member.

33. The workbench support system of claim 32, further comprising at least one utility portion, provided at top edges of support bars configured for supporting a utility member.

34. The workbench support system of claim 32, comprising a first set of two substantially parallel disposed support legs and a second set of two support legs, the two support legs of each set being connected at their top end and their bottom end with a connecting support bar, together constituting substantially rectangular support frames, optionally wherein the support frames are disposed in parallel in the operative configuration or are angled one with respect to the other.

35. The workbench support system of claim 32, wherein sliding displacement is facilitated by a rail system provided at an inner face of each of the support legs and a storage rail configured to snuggly receive therein the connecting bar associated with the opposite set of legs.

36. The workbench support system of claim 32, further provided with at least one of (i) a locking mechanisms locking a utility member to the workbench support system, (ii) a carrying handle, or (iii) one or more organizers detachably attachable thereto.

37. The workbench support system of claim 32, being configured with and least one utility portion configured to receive a utility member and deployable between an operative position and a collapsed position, the utility member being configured for articulation to the support system in an operative position and further configured to be stowed within the support system when in the collapsed position, wherein the thickness of an assembly comprising the utility member and the support system in the stowed position does not exceed the thickness of the workbench support system when folded.
